(19) United States
(12) Patent Application Publication
(10) Pub. No.: US 2007/0124000 A1
(43) Pub. Date: May 31, 2007

(54) Processes for project-oriented job-site management

(75) Inventors: Eric Alan Moughler, Metamora, IL (US); Keith Albert Turcot, Peoria, IL (US); Bhavin Jagdlshbhai Vyas, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/289,309

(22) Filed: Nov. 30, 2005

(51) Int. Cl. G05B 15/02

(52) U.S. Cl. 700/9; 705/1; 701/50

(57) ABSTRACT

Systems and methods are disclosed for project-oriented job-site management. According to one embodiment, a system is disclosed for managing a project environment including a work machine performing operations associated with a project included in the project environment. The system may include a project management system configured to store a first set of project specifications for the project in a storage device, receive operation data from the work machine reflecting the operations of the work machine, analyze the operation data to determine the status of the work machine, and generate a second set of project specifications based on the status of the work machine. The system may also include a project subscriber configured to receive the second set of project specifications from the project management system and determine an action to be taken with the work machine based on the status of the work machine. The project management system provides a command to the work machine for adjusting the operations of the work machine associated with the project based on the second set of project specifications and the determined action.

### TECHNICAL FIELD

This application relates generally to remote site management and, more particularly, to a system and method for project-oriented job-site management for a work-machine environment.

### BACKGROUND

Project management is an important aspect in any cost-conscious business environment, particularly those in which resources are deployed over large geographical areas to complete individual portions of the same project. Traditionally, project managers are deployed to remote sites to manage the resources used to perform respective portions of a given project. The project managers may report back to a central office or project headquarters, where a lead project manager (e.g., division manager, director, etc.) manages the entire project. The lead project manager may determine what changes, if any, need to be made to ensure timely and cost-effective execution of the project.

This conventional method for managing large, geographically remote projects may be inefficient, costly, and require a large number of personnel. Furthermore, such conventional project management methods may be unreliable because each project manager often possesses differing levels of managerial and technical skills, which may lead to non-uniform or incomplete application of project management principles. This may lead to increased overhead costs, inefficient utilization of equipment assets, and/or loss of revenue over the course of the project.

One method for managing a fleet of remote assets is described in U.S. Patent Application Publication No. 2002/0065698 (“the '698 publication”) to Schick et al. The '698 publication describes a system for managing a plurality of mobile assets. The system may collect and process data from the mobile assets to develop actual usage statistics of the mobile assets. The system then distributes the information via a global information network. In one instance, the system may use the collected information to predict potential vehicle failure and to schedule maintenance and repair work for an asset based on the predicted failure. In another instance, the system may provide a list of recommended service centers to an operator of an asset when service is required. The service data and recommendations for each mobile asset may be posted on a web-site accessible though the global information network for remote access by users of the system.

Although the system of the '698 publication may provide repair and maintenance information usable in managing assets, it may still suffer from the same efficiency problems experienced by other conventional systems. For example, the system of the '698 publication only manages aspects related to the operation of individual work machines, but does nothing to provide project and/or job-site management capabilities employing a large number of geographically dispersed assets. Thus, significant personnel time and resources may still be required to provide the necessary project management capabilities for a plurality of assets operating in a distributed project environment.

Furthermore, because the system of the '698 publication does not provide project-oriented management, should an asset associated with a work environment become disabled, the system is not equipped to make adjustments to the work machine environment as data is being received. As a result, project managers may be required to manually analyze the collected operation data. Thus, businesses that require real-time project management updates may become inefficient should potential project-impacting events not be immediately recognized and/or corrected.

Moreover, because data collected by the system of the '698 publication is not integrated into a project management system, managers of assets that operate within the same project environment may not be capable of analyzing the status of the entire project based on “real-time” information collected from the assets. As a result, the system of the '698 publication may not be equipped to identify inefficient assets in order to take corrective action to abide by the requirements of the project.

The disclosed system and method for project-oriented job-site management are directed towards overcoming one or more of the problems set forth above.

### SUMMARY OF THE INVENTION

Systems and methods are disclosed for project-oriented job-site management. According to one embodiment, a system is disclosed for managing a project environment including a work machine performing operations associated with a project included in the project environment. The system may include a project management system configured to store a first set of project specifications for the project in a storage device, receive operation data from the work machine reflecting the operations of the work machine, analyze the operation data to determine the status of the work machine, and generate a second set of project specifications based on the status of the work machine. The system may also include a project subscriber configured to receive the second set of project specifications from the project management system and determine an action to be taken with the work machine based on the status of the work machine. The project management system may provide a command to the work machine for adjusting the operations of the work machine associated with the project based on the second set of project specifications and the determined action.

In another embodiment, a method is disclosed for project-oriented job-site management. The method may include storing, in a storage device, a first set of project specifications. The method may further include receiving, in a project management system, operation data indicative of an operational status of a first work machine. The method may also include modifying the first set of project specifications to produce a second set of project specifications based on the operation data of the first work machine. The method may further include distributing the second set of project specifications to one or more project subscribers associated with a project environment.

### BRIEF DESCRIPTION OF THE DRAWINGS

FIG. 1 illustrates an exemplary disclosed project environment consistent with certain disclosed embodiments;

FIG. 1A provides a schematic illustration of an exemplary project management system in accordance with certain disclosed embodiments;

FIG. 2 illustrates a flowchart depicting an exemplary project-oriented job-site management process consistent with certain disclosed embodiments; and

FIG. 3 illustrates a flowchart depicting an exemplary project status reporting process consistent with certain disclosed embodiments.

### DETAILED DESCRIPTION

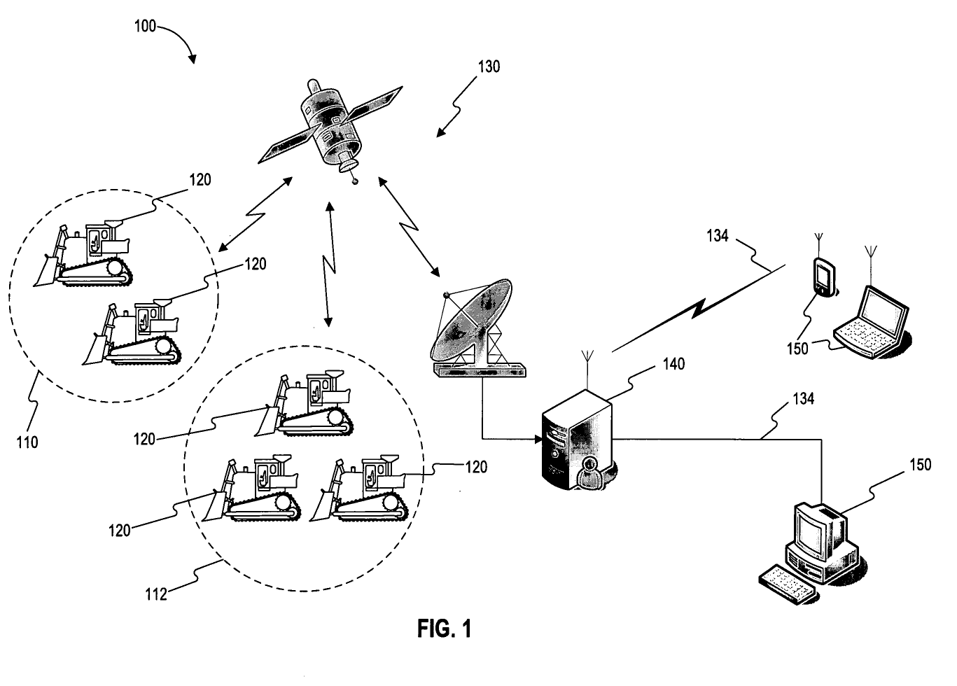

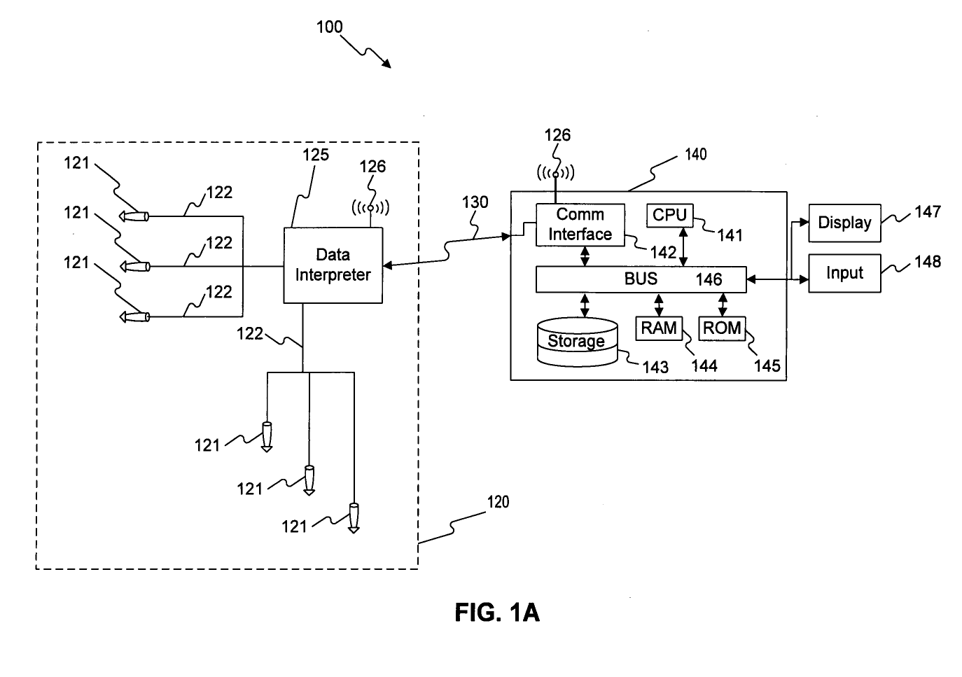

FIG. 1 illustrates an exemplary project environment 100 consistent with certain disclosed embodiments. Project environment 100 may include components that perform individual tasks that contribute to a work machine environment task, such as mining, construction, transportation, agriculture, manufacturing, or any other type of task associated with other types of industries. For example, project environment 100 may include one or more work machines 120 coupled to a project management system 140 via a communication network 130. The project environment 100 may be configured to monitor, collect, and filter information associated with an operation of one or more work machines 120 and distribute the information to one or more back-end systems, such as project management system 140 and/or a project subscriber 150. It is contemplated that additional and/or different components than those listed above may be included in project environment 100.

Work machines 120 may each be a fixed or mobile machine configured to perform an operation associated with project environment 100. Thus, work machine, as the term is used herein, refers to a fixed or mobile machine that performs some type of operation associated with a particular industry, such as mining, construction, farming, etc. and operates between or within project environments (e.g., construction site, mine site, power plants, etc.) A non-limiting example of a fixed machine includes an engine system operating in a plant or off-shore environment (e.g., off-shore drilling platform). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment. A work machine may be driven by a combustion engine or an electric motor. The types of work machines listed above are exemplary and not intended to be limiting. It is contemplated that project environment 100 may implement any type of work machine. Accordingly, although FIG. 1 illustrates work machines 120 as track-type tractor machines, each work machine 120 may be any type of work machine operable to perform a particular function within project environment 100. Furthermore, it is contemplated that work machines 120 may include a first set of work machines 110 and a second set of work machines 112 for associating the operations of particular machines to groups of work machines. Furthermore, it is also contemplated that first and second sets of work machines may be located in separate work sites located remotely from each other, and with project management system 140.

In one embodiment, each work machine 120 may include on-board data collection and communication equipment to monitor, collect, and/or transmit information associated with an operation of one or more components of work machine 120. As shown in FIG. 1A, work machine 120 may include, among other things, one or more monitoring devices 121, such as sensors, electronic control modules (not shown), etc. coupled to one or more data interpreters 125 via communication lines 122, one or more transceiver devices 126, and/or any other such components for monitoring, collecting, and communicating information associated with the operation of work machine 120. Each work machine 120 may also be configured to receive information from off-board systems, such as a project management system 140, a project subscriber 150, or any other back-end communication system. The components described above are exemplary and not intended to be limiting. Accordingly, the disclosed embodiments contemplate each work machine 120 including additional and/or different components than those listed above.

Data interpreter 125 may be operable to collect operational information associated with work machine 120 and determine a productivity based on the collected operational information and one or more task parameters assigned to work machine 120. For example, data interpreter 125 may collect operational information associated with an operation of work machine 120 during the execution of an assigned task. Data interpreter 125 may determine the productivity of work machine 120 based on the collected operational information and one or more task parameters associated with the assigned task. Data interpreter 125 may distribute the operational information and productivity information to project management system 140 via communication network 130.

Communication network 130 may include any network that provides two-way communication between each work machine 120 and an off-board system, such as project management system 140. For example, communication network 130 may communicatively couple work machines 120 to project management system 140 across a wireless networking platform such as, for example, a satellite communication system. Alternatively and/or additionally, communication network 130 may include one or more broadband communication platforms appropriate for communicatively coupling one or more work machines 120 to project management system 140 such as, for example, cellular, Bluetooth, microwave, point-to-point wireless, point-to-multipoint wireless, multipoint-to-multipoint wireless, or any other appropriate communication platform for networking a number of components. Although communication network 130 is illustrated as a satellite-based wireless communication network, it is contemplated that communication network 130 may include wireline networks such as, for example, Ethernet, fiber optic, waveguide, or any other type of wired communication network.

Project management system 140 may be a computing system configured to receive, analyze, and distribute operational data received from one or more work machines 120 via communication network 130. For purposes of this disclosure, operation data may include operational and/or productivity information indicative of one or more parameters associated with the operation of a particular work machine 120. For example, operational information may include status data (e.g., engine on/off, parked, stationary, etc.), load weight, engine speed, engine temperature, oil pressure, location, GPS coordinates, engine hours, tire wear, component fatigue, fluid levels, pressure data, work machine position information, and any other parameter associated with the operation of a work machine. Productivity information may include information indicative of the productivity of work machine 120 such as, for example, an amount of material moved, how quickly the machine was able to complete a particular task associated with project environment 100, an amount of energy expended by work machine 120 during operations within project environment 100, an efficiency in completing an assigned task, or any other suitable indicator of work machine productivity.

Project management system 140 may also communicate with other systems (e.g., project subscriber 150, one or more site-managers (not shown), etc.) via communication link 134. For example, communication link 134 may include one or more data links that directly connect project management system 140 to another system (e.g., project subscriber 150) as part of a point-to-point or point-to-multipoint network. Alternatively and/or additionally, communication link 134 may be include a common access communication platform, such as the Internet, a private intranet, a corporate workgroup, or any other communication platform. Communication link 134 may include electrical wires, twisted pair cables, optical fiber cables, wireless links (e.g., infrared links, Bluetooth connections, satellite communication links, etc.), or any other media appropriate for transmitting data. Further, communication link 134 may be configured with hardware and/or software components that enable data to be transmitted using an analog format, a digital format, a combination thereof, or any other form of data communication.

In one embodiment, project management system 140 may include hardware and/or software components that perform processes consistent with certain disclosed embodiments. For example, as illustrated in FIG. 1A, project management system 140 may include one or more transceiver devices 126, a central processor unit (CPU) 141, a communication interface 142, one or more computer-readable memory devices, including storage device 143, a random access memory (RAM) module 144, and a read-only memory (ROM) module 145, a display device 147, and/or an input device 148. The components described above are exemplary and not intended to be limiting. Furthermore, it is contemplated that project management system 140 may include alternative and/or additional components than those listed such as, for example, one or more software programs including instructions for executing process steps when executed by CPU 141.

CPU 141 may be one or more processors that execute instructions and process data to perform one or more processes consistent with certain disclosed embodiments. For instance, CPU 141 may execute software that enables project management system 140 to request and/or receive operation data from data interpreter 125 of work machines 120. CPU 141 may also execute software that stores collected operation data in storage device 143. In addition, CPU 141 may execute software that enables project management system 140 to analyze operation data collected from one or more work machines 120, modify one or more project specifications of the project environment 100, and/or-provide customized project status reports, including recommendations for modifications to project specifications and/or operational instructions for executing the project. A project specification may include one or more characteristics associated with the execution of a work machine project such as, for example, a project schedule for completion of the work machine project, a productivity schedule for each respective work machine operating in project environment 100, a project productivity rate (e.g., percentage of project completed per month), a project budget, a productivity quota for work machine 120, maintenance schedules, hours of operation for the work machine and/or job-site, an assignment for a particular work machine, a job-site inventory, and any other type of characteristic associated with project management. Furthermore, a project specification may include a guideline that, when used as a project benchmark, may assist in the appropriate execution of a project performed within project environment 100. These benchmarks may include incremental completion milestones, budget forecasts, and any other type of performance and/or operation benchmark.

CPU 141 may be connected to a common information bus 146 that may be configured to provide a communication medium between one or more components associated with project management system 140. For example, common information bus 146 may include one or more components for communicating information to a plurality of devices. CPU 141 may execute sequences of computer program instructions stored in computer-readable medium devices such as, for example, a storage device 143, RAM 144, and/or ROM 145 to perform methods consistent with certain disclosed embodiments, as will be described below.

Communication interface 142 may include one or more elements configured for communicating data between project management system 140 and one or more data interpreters 125 via transceiver device 126 over communication network 130. For example, communication interface 142 may include one or more modulators, demodulators, multiplexers, demultiplexers, network communication devices, wireless devices, antennas, modems, and any other type of device configured to provide data communication between project management system 140 and remote systems or components.

One or more computer-readable medium devices may include one or more storage devices 143, a RAM 144, ROM 145, and/or any other magnetic, electronic, or optical data computer-readable medium devices configured to store information, instructions, and/or program code used by CPU 141 of project management system 140. Storage devices 143 may include magnetic hard-drives, optical disc drives, floppy drives, or any other such information storing device. A random access memory (RAM) device 144 may include any dynamic storage device for storing information and instructions by CPU 141. RAM 144 also may be used for storing temporary variables or other intermediate information during execution of instructions to be executed by CPU 141. During operation, some or all portions of an operating system (not shown) may be loaded into RAM 144. In addition, a read only memory (ROM) device 145 may include any static storage device for storing information and instructions by CPU 141.

Project management system 140 may include one or more input devices configured to receive one or more project specifications (e.g., project schedule, job-site inventory, project budget, individual work machine tasks, etc.) indicative of a project to be performed by a plurality of work machines from one or more users associated with project environment 100. For example, project management system may include a console with integrated keyboard and mouse to allow a user of project management system (e.g., customer, client, etc.) to input project specifications corresponding to a particular project to be performed as part of project environment 100. Project management system 140 may store the project specifications in storage device 143 for future analysis and/or modification. The components listed above are exemplary only and not intended to be limiting. Accordingly, additional, fewer, and/or different input devices may included with project management system 140.

Project management system 140 may be coupled to on-board data collection and communication equipment to monitor, collect, and/or transmit information associated with an operation of one or more components of work machine 120. In one embodiment, project management system 140 may be coupled to one or more data interpreters 125 on respective work machines 120 via transceiver device 126 to collect operation data from one or more monitoring devices 121, such as sensors, electronic control modules, etc. (not shown), and/or any other such components for monitoring, collecting, and communicating information associated with the operation of a respective work machine 120. Project management system 140 may also be configured to transmit information to work machine 120 via communication network 130.

Project management system 140 may also include other components that perform functions consistent with certain disclosed embodiments. For instance, project management system 140 may include a memory device configured to store, among other things, one or more software applications including, for example, a database program, a graphical user interface, data acquisition and analysis software, or any other appropriate software applications for operating and/or monitoring project environment 100.

Project management system 140 may further include one or more components to analyze operational information from work machines 120 with respect to predefined design specifications stored in storage device 143. For example, in addition to CPU 141, project management system 140 may be configured with on-board logic circuitry that analyzes operation data received from work machines 120. Predefined design specifications include one or more data indicative of an appropriate operation of a particular work machine 120, type of work machine 120, or its constituent components. For example, predefined design specifications may include, for example, benchmark operational ranges, stress-strain thresholds, mechanical force limits, fuel economy, temperature ranges, pressure ranges, load limits, or any other such predefined specification benchmarking the performance of a work machine during normal operations. Moreover, each of the predefined design specifications may be associated with one or more components of work machine 120 such as, for example, a combustion engine, a motor, a transmission, a fluid cooling system, a generator, a cooling tank, a lubricating fluid, or any other component of work machine 120.

Project management system 140 may also be configured to compare the received operation data from a work machine 120 to one or more predefined design specifications and determine whether the received operation data is operating within a predetermined range. For example, project management system 140 may receive operation data from, among other things, an electric motor of a particular work machine 120. The operation data may include data indicative of a field current through a stator winding of the motor. Project management system 140 may compare the received field current data to predefined design specifications related to the field current of the motor to determine whether the received field current (i.e., actual field current during motor operation) conforms to the design tolerances associated with the predefined design specifications. Although this example illustrates the received operation data as being associated with one component, it is contemplated that received operation data may include any data indicative of an operation of work machine 120 or any of its constituent components. Furthermore, project management system 140 may be configured to analyze operation data associated with any number of components of work machine 120, and may perform analyses of these components in series, parallel, simultaneously, sequentially, or any combination thereof.

In certain embodiments, project management system 140 may modify a project specification associated with project environment-100 based on the status of one or more work machines 120. For example, project management system 140 may modify a project specification to compensate for any work machines that have been incapacitated or taken off-line for service. Alternatively and/or additionally, project management system 140 may modify one or more additional and/or different project specifications associated with other machines operating within the same work site to reflect a respective change associated with project environment 100.

Project subscriber 150 may include a computer system that is configured to receive data from project management system 140 in a manner consistent with the disclosed embodiments. For example, project subscriber 150 may include one or more computer terminals operated by respective users. Alternatively and/or additionally, project subscriber 150 may include personal data assistant systems (PDA), wireless communication devices (e.g., pagers, phones, etc.), notebook computers, diagnostic computer systems, data analyzers, or any other such computing devices configured to receive and process information, such as operation data. In one embodiment, project subscriber 150 may be associated with one or more sections of a business entity associated with managing one or more remote project sites within project environment 100. For instance, project subscriber 150 may be associated with a particular division of a business entity associated with project environment 100, such as a project management division, an operations division, a maintenance and repair division, a procurement division, and/or any other type of business entity that may be associated with project environment 100. In another embodiment, project subscriber 150 may be associated with a business entity that is affiliated with one or more sets of work machines 120, such as first set 110. For example, project subscriber 150 may be associated with a site-manager that controls the operation and productivity of the first set of work machines 110. Alternatively and/or additionally, different project entities may be associated with different business entities and/or work machines 120. Accordingly, the above descriptions are exemplary and not intended to be limiting. The disclosed embodiments contemplate any correlation (or none at all) between one or more business entities, and/or sections thereof, and the components of project environment 100.

Project subscriber 150 may be associated with a business entity affiliated with project environment 100 and may be configured to communicate with project management system 140. In one embodiment, project subscriber 150 may transmit and receive operation data to and from project management system 140 associated with one or more work machines 120 operating within project environment 100. For example, project subscriber 150 may be an on-site maintenance and repair division that receives operation data from project management system 140 associated with one or more work machines 120 or a set of work machines 110.

Project subscriber 150 may be configured to analyze the received operation data to determine what, if any, action needs to be taken on a particular work machine 120 or component of work machine 120 (e.g., repair, replacement, etc.) In addition, should operation data received from a work machine 120 indicate that a component of the work machine requires replacement, project subscriber 150 may determine the appropriate actions that need to be taken to complete the project according to one or more project specifications. Alternatively, project subscriber 150 may determine, upon analysis, that the project specifications cannot be met given the current operating conditions of project environment 100. Project subscriber 150 may recommend that the “current” project specifications be modified, to reflect the “real-time” operation data associated with project environment 100.

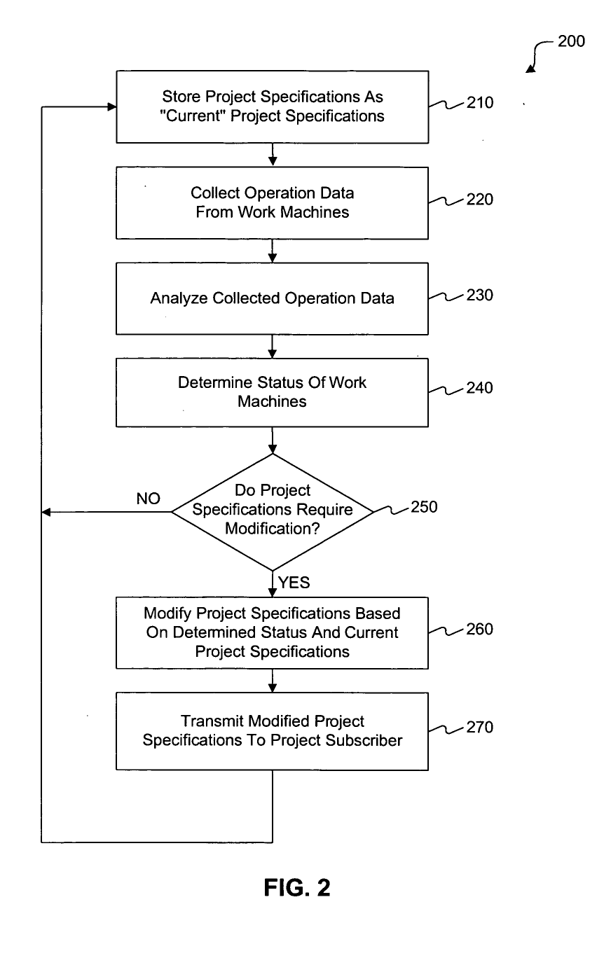

As explained, systems and methods consistent with certain disclosed embodiments provide an environment that allows project-oriented job-site management of multiple work machines and project sites remotely based on “real-time” operation data received from one or more work machines 120. FIG. 2 shows a flowchart 200 that illustrates an exemplary project-oriented job-site management process consistent with certain disclosed embodiments. In one embodiment, project management system 140 may-receive one or more project specifications from a user associated with project environment 100. Project management system 140 may then store the received project specifications as the “current” project specifications (Step 210). For example, a project manager in charge of multiple job-sites of project environment 100 may input project specifications corresponding to a project to be performed as part of project environment 100 into project management system 140. A CPU 141 of project management system 140 may store the project specifications as the “current” project specifications in storage device 143 for future access by project management system 140..

At some point, project management system 140 may receive operation data from one or more work machines operating within project environment 100 (Step 220). For example, project management system 140 may receive operation data via communication network 130 from one or more data interpreters 125 associated with one or more work machines 120 that are performing tasks associated with certain projects. The operation data may include one or more characteristics indicative of the operation of work machine 120 and/or one or more of its constituent components.

Project management system 140 may analyze the collected operation data based on the stored predetermined design specifications associated with work machine 120 and/or one or more of its components (Step 230). For example, project management system 140 may determine if the collected operation data conforms to one or more predefined design specifications indicative of acceptable operation of work machine 120. Alternatively and/or additionally, project management system 140 may analyze the collected operation data with respect to the “current” project specifications supplied by the user of project environment 100.

Based on the analysis of the collected operation data, project management system 140 may determine the status of each of work machines (Step 240). For example, should the analysis of the collected operation data indicate that a fault condition is present on a particular work machine, project management system 140 may set the status of that work machine to reflect the fault condition (e.g., idle, off, shutdown, disabled, etc.) Alternatively and/or additionally, project management system 140 may determine the productivity status of each work machine 120 and/or a collection of work machines, such as work machine set 100, 112. For example, if the project specifications indicate that the work machine is budgeted to haul a certain weight per day, project management system may set the status of the work machine based on that machine's performance expectations (e.g., a percentage of productivity with respect to a given project specification). For instance, project management system 140 may define the status of a given work machine as being 80% efficient in hauling material.

Furthermore, project management system 140 may assess the overall status and/or effectiveness of project environment 100 based on the status and/or other related information for the work machine used in one project environments. For example, if each work machine 120 of a particular set of work machines 110 is operating at 80% efficient for a particular task associated with project environment 100, project management system 140 may set the status for the particular task to “behind schedule”. Accordingly, project management system may update and/or store the status of the project environment 100 for future analysis.

Based on the status of the work machines operating within project environment 100, project-management system 140 may determine whether the project specifications require modification (Step 250). Should the status of the work machines indicate that the project environment is operating appropriately with respect to the “current” project specifications, the “current” project specifications may be re-applied in subsequent monitoring iterations (Step 250: No). For example, if the requirements set forth in the project specifications for the respective work machine are being met, project management system 140 may determine that the “current” project specifications may be sufficient for appropriate execution of the project. Thus, the “current” project specifications may be reused until such time that the “real-time” operation data from one or more work machines 120 indicate that the current project specifications are insufficient to meet the project specification for project environment 100.

Alternatively, project management system 140 may determine that the “current” project specifications may be inadequate, invalid, and/or uncharacteristic and require modification (Step 250: Yes). For example, if a work machine operating in project environment 100 is taken out of service because of a fault condition, project management system 140 may determine that a project schedule involving the faulty machine is no longer valid and may require modification. In addition, the project budget may need modification to account for the unscheduled maintenance of the out-of-service machine and/or the cost of a replacement machine.

Project management system 140 may modify the project specifications based on the determined status of one or more work machines 120 operating within project environment 100 (Step 260). For instance, referring to the example described above, should one or more work machines be taken out of service because of a fault condition, project management system 140 may adjust the project schedule to accommodate for the decrease in job-site productivity caused by the machine being taken out-of-service. In one embodiment, project management system 140 may adjust the project specifications to include a replacement work machine. Accordingly, the project specifications may be modified to reflect the additional cost of the replacement work machine.

Once one or more project specifications are modified, project management system 140 may transmit the modified project specifications to one or more project subscribers 150 (Step 270) for execution and implementation within project environment 100. In one exemplary embodiment, project management system 140 transmits the modified project specifications to project subscribers 150 via communication network 130 and/or communication link 134. A subscriber may be associated with a business entity affiliated with project environment 100. As such, the subscriber and/or the business entity may determine what operational changes, if any, may be required to ensure that a given project is executed appropriately and according to the specifications defined by one or more users (e.g., managers, etc.) For example, project management system 140 may receive information from project subscriber 150 associated with a maintenance division indicating that a first set of work machines 110 will be out-of-service for a 24-hour period. Project management system 140 may modify the productivity quota for each work machine 120 among the second set of work machines 112 in response to the lost productivity of first set of work machines 110. Project management system may send data reflecting the respective productivity quota change to each operator of the respective work machine 120, allowing each operator to make immediate operational adjustments according to the respective quota change. Alternatively and/or additionally, the project specifications may be transmitted to a procurement division notifying whether additional work machines need to be acquired to replace and/or supplement the existing machines located at a particular job-site. As such, project subscribers 150 may take the appropriate action necessary to respond to the modified project specifications received from the project management system 140.

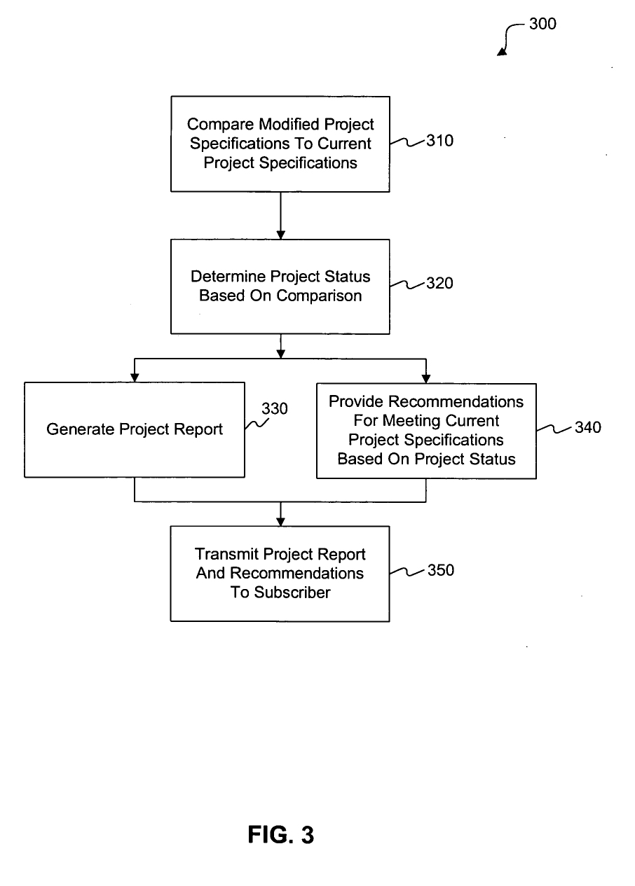

As explained, methods and systems consistent with certain disclosed embodiments enable project management system 140 and/or project subscribers 150 to improve the job-site management of a project environment 100 based on “real-time” operation data received from work machines 120. Flowchart 300 of FIG. 3 illustrates an-exemplary project status reporting process consistent with certain disclosed embodiments. In accordance with one exemplary disclosed embodiment, project management system 140 may compare modified project specifications with “current” project specifications (Step 310). Project management system 140 may employ a variety of different comparison methods known in the art to provide a output indicative of the comparison of the modified specifications. For example, project management system 140 may use statistical comparison techniques implemented by software executed by CPU 141 to determine a degree of correlation and/or deviation between the modified and current project specifications.

Based on the comparison, project management system 140 may determine a project status of project environment 140 (Step 320). For example, the project status may indicate a general status of the project performed within the project environment 100 (e.g., on-time, delayed, ahead-of-schedule, on-budget, over-budget, etc.) based on the degree that the modified specifications deviate from the “current” specifications. For instance, a minor deviation between the modified project specifications may not have an effect on the overall status of the project environment. On the other hand, other deviations, such as a major deviation, (e.g., multiple work machines being taken out-of-service, weather conditions prohibiting work at one or more job-sites, a major productivity decrease at a job-site, etc.) may cause project management system 140 to change the project status of project environment 100.

Based on the determined project status, project management system 140 may provide a project report summarizing the project status (Step 330). A project report may include data reflecting the current status of a projects, projects, or project environment 100. In one embodiment, project management system 140 may provide a project report as a data structure that is stored as a data file. In addition, project management system 140 may recommend possible alternative and/or additional modifications to the project specifications that may result in less deviation from the current project specifications (Step 340). For example, project management system 140 may indicate that the number of work machines 120 specified in the modified project specifications should be increased, which may result in the expedited completion of the project. In one embodiment, the recommendations may be based on a critical parameters specified by a user of project environment 100 (e.g., project manager, customer, etc.). For example, if budget is a primary concern for the customer, the recommendations may include ways to decrease the overall cost associated with the project environment, with less regard for other parameters, such as project schedule. Alternatively, if project schedule is of particular concern to the customer, the recommendations may include ways to increase the productivity of the project environment with less emphasis on costs and/or budget.

The project report and recommendations generated by project management system 140 may be provided to one or more project subscribers 150 (Step 350). According to one embodiment, project management system 140 may be configured to automatically submit the project report and recommendations to project subscriber 150 at certain intervals, such as prior to the beginning of each work shift at each job-site. It is also contemplated that the project report may be transmitted periodically (e.g., once per hour, day, week, etc.) based on the need of the particular project subscriber 150. Alternatively and/or additionally, project management system 140 may be configured to transmit the project report in response to a certain event (e.g., failure of one or more machines, etc.) or a request from a project subscriber 150. In another embodiment, project management system 140 may provide the project report and/or recommendations to a user associated with project management system 140 via a display device 147. Additionally, project management system 140 may provide project report and/or recommendations to an external computer system other than project subscriber 140, such as a work management site located at a work site associated with one or more work machines 120.

According to one exemplary embodiment, project management system 140 may receive a complete project package, including a plurality of project specifications that may define the benchmarks and/or guidelines for completing the project according to customer desires. For example, a customer may task a Company A with clearing several parcels of land, each parcel being located in a different geographical area and having a unique set of environmental conditions (e.g., mountains, swamps, deserts, etc.) The customer may further indicate that the land must be cleared by a certain deadline with a maximum cost not to exceed a certain amount. Project management system 140 may store these customer defined project specifications as “priority” specifications and provide additional specifications such as, for example, the number of machines required per job-site, the estimated productivity (amount of material moved, land excavated, etc.) required of each machine per day, the number of work shifts at each site, etc., to complete the project within the time schedule and budget requirements of the customer. The priority specifications and the additional specifications may be stored within storage device 143 of project management system 140 as the “current” project specifications.

Upon commencement of the project, operation data from each work machine 120 may be automatically transmitted in the “real-time” to project management system 140. Project management system 140 may determine the status of each of work machines 120, the status of each individual job-site based on the status of work machines 120, and/or the status of the project based on one of the job-site status and the status of work machines 120. Project management system 140 may make adjustments to the project specifications based on the status of each of work machines 120, each job-site, and/or the project as a whole, in order to complete the project within the guidelines set forth in the customer priority specifications. For example, if operation data indicates that a first job-site located in a swampy environment has decreased productivity due to flooding, project management system 140 may modify the project specifications to reassign all work machines operating in the first job-site to a second job-site until the flooding has subsided, increasing the productivity at the second job-site to maintain the project schedule and productivity guidelines. Once work can resume at the first site, project management system 140 may modify the project specifications to re-assign the work machines to the first site, along with additional machines from the second site. Alternatively and/or additionally, project specifications may be modified to employ additional machines to the previously flooded site to compensate for the lost productivity, assuming the desired budgetary requirements will not be jeopardized.

In addition to modifying project specifications, project management system 140 may provide project status reports, including modified specifications, recommendations for alternative courses of action, and any other project-specific analysis to one or more project subscribers 150 of project environment 100. For example, project management system 140 may provide modified project specifications to a foreman associated with respective job-sites, one or more operators of work machines 120, a customer liaison, a business manager, a lead project manager responsible for overseeing the project, etc. This integrated distribution of project reports, including modified specifications and project specification recommendations, may provide all entities associated with the project “real-time” analysis and status of the project. Thus project managers, work machine operators, business decision makers, and customers may monitor project environment 100 via project management system 140 to check the status of the project.

In another exemplary embodiment, project management system 140 and project subscriber 150 may be combined into a single system. For example, project management system 140 may include one or more project subscribers as associated with a particular business entity. Alternatively and/or additionally, project subscribers may each be a hardware and/or software systems included within project management system dedicated to a particular work machine 120 or set of work machines 110, 112.

Furthermore, project management system 140 may contain software that, when executed by CPU 141, may perform processes consistent with certain disclosed embodiments. For example, project management system 140 may contain programs that automatically analyze of the operation data and/or the project specifications. Project management system 140 and/or programs executed within project management system may then provide recommendations to adjust the project specifications and/or operations of work machines 120 based on the analysis.

Project management system 140 may transmit commands to respective work machines 120 to adjust their operations based on the new project specifications and/or recommendations. Accordingly, the work machines 120 may adjust operations immediately (i.e., “on-the-fly) in response to the respective commands sent by project management system 140. For example, project management system 140 may transmit a command to an operator of a particular work machine “A” to pick up piles X and Y located in project environment 100 in response to modifications made to the project specifications. Similarly, project management system 140 may transmit a command to an operator of a work machine “B” to stop hauling from site Y and immediately go to a maintenance facility for scheduled maintenance. Alternatively and/or additionally, project management system 140 may transmit operational commands to work machines 120 such as, for example, commands to electronic control modules connected to data interpreter 125 to adjust some parameter(s) of the work machine, such as, speed, direction, transmission gear, location, etc. in response to certain modifications to the project specifications.

It is contemplated that methods and systems consistent with certain disclosed embodiments may include additional and/or different steps than those listed, and that the disclosed embodiments may be executed in additional and/or different project environments than those listed. As such, the examples described in the above disclosed embodiments are not intended to be limiting.

### INDUSTRIAL APPLICABILITY

Methods and system consistent with certain disclosed embodiments enable a system or user to manage certain aspects of a project environment based on the “real-time” operation data collected from work machines operating within the project environment. A project environment that employs processes and elements consistent with certain disclosed embodiments allows for a user or project subscriber to manage, or assist in the management of, a project, such as projects with multiple remote job-sites, based on operation data received from the work machines operating at each of the job-sites. Additionally, certain disclosed embodiments enable a project management system 140 to identify, modify, and analyze certain aspects of the project environment to determine improvements to the project according to one or more user defined specifications.

Although the disclosed embodiments are directed toward a project management system 140 for a project environment 100 employing work machines 120, the disclosed system and method for project-oriented job-site management may be applicable to any environment where it may be desirable to manage projects using “real-time” data collected from equipment operating within a work environment. Specifically, the disclosed system and method for project-oriented job-site management may collect and analyze operation data from one or more work machines 120 and modify the project specifications, including operational parameters of project environment 100, according to the collected data.

The disclosed system for improving the production of a work machine enables a project management system 140 to collect operation data from one or more work machines 120 and modify the project specifications of the work machines as the data is being received based on the performance of the work machines operating in project environment 100. Thus, time delays associated with the analysis and distribution of modified project specifications, including project schedules, project budgets, and work machine productivity, may be significantly reduced, because, for example, a user is no longer required to manually analyze operation data to determine project specifications.

Furthermore, the disclosed embodiments associated with project management system 140 may increase reliability of project management processes. For example, because project management system 140 analyzes operation data from each of the work machines operating within a project environment 100, each set of operation data may be evaluated uniformly and objectively, as opposed to conventional systems that rely on individual job-site managers to evaluate or analyze the operation collected from the respective site leading to potentially non-uniform and often subjective data analysis. As a result, project environments that employ processes consistent with certain disclosed embodiments may increase the reliability of the project management capabilities of project environment I 00.

Moreover, because project management system 140 is coupled to each work machine 120 and project subscriber 150 via communication network 130 and communication links 134 respectively, “real-time” data may be collected, analyzed, and reported through a common system, which may result in more efficient and seamless project management than in conventional systems. In addition, because project management system 140 may act as a common hub for data collection and analysis, users of project environment 100 may have greater access to the operation data, analysis data, and reports.

Personnel productivity may also increase as project management system 140 may configured as a fully remote operational system, thereby reducing the need for individual project management personnel in remote job-site locations. Furthermore, because project management system 140 may be configured to automatically generate preliminary reports and provide recommendations for meeting project specifications, project management personnel may dedicate more of their time to more critical tasks without having to unnecessarily invest time in preliminary data acquisition and analysis.

It will be apparent to those skilled in the art that various modifications and variations can be made to the disclosed system and method for project-oriented job-site management. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A system for managing a project environment including a work machine performing operations associated with a project included in the project environment, the system comprising:
a project management system configured to:
store a first set of project specifications for the project in a storage device,
receive operation data from the work machine reflecting the operations of the work machine,
analyze the operation data to determine the status of the work machine,
generate a second set of project specifications based on the status of the work machine; and
a project subscriber configured to receive the second set of project specifications from the project management system and determine an action to be taken with the work machine based on the status of the work machine,
wherein the project management system provides a command to the work machine for adjusting the operations of the work machine associated with the project based on the second set of project specifications and the determined action.

2. The system of claim 1, wherein the command includes a signal to an electronic control module of the work machine that automatically adjusts the operations of the work machine.

3. The system of claim 1, wherein the project management system is further configured to:
receive operation data from a second work machine performing operations associated with the project,
analyze the operation data from the second work machine to determine the status of the second work machine, and
adjust the second set of project specifications based on the status of the second work machine.

4. The system of claim 3, wherein the project management system is further configured to provide a second command to adjust the operations of the work machine and the second work machine based on a status of the second work machine.

5. The system of claim 1, wherein the project management system is further configured to:
compare the first set of project specifications with the second set of project specifications;
generate a project report for the project environment based on the comparison of the first set of project specification with the second set of project specifications; and
provide the project report to the project subscriber.

6. The system of claim 1, wherein the project management system is further configured to adjust the second set of project specifications based on a change in a project budget for the project environment.

7. The system of claim 1, wherein the project management system is further configured to adjust the second set of project specifications based on a fault indicator received from the work machine.

8. The system of claim 7, wherein the project management system is further configured to schedule maintenance for the work machine based on the fault indicator received from the work machine.

9. The system of claim 1, wherein generating the second set of project specifications includes modifying a first set of project specifications in response to a request from the project subscriber.

10. The system of claim 1, wherein one or more of the first and second set of project specifications include a priority specification designated by the project subscriber.

11. The system of claim 10, further including adjusting the second set of project specifications based on the received operation data from the work machine according to the priority specification.

12. A method for project-oriented job-site management, comprising:
storing, in a storage device, a first set of project specifications;
receiving, in a project management system, operation data indicative of an operational status of a first work machine;
modifying the first set of project specifications to produce a second set of project specifications based on the operation data of the first work machine; and
distributing the second set of project specifications to one or more project subscribers associated with a project environment.

13. The method of claim 12, further including:
receiving, in the project management system, operation data indicative of an operational status of a second work machine; and
adjusting the second set of project specifications based on the operational status of the second work machine.

14. The method of claim 13, further including providing a command to each of the first and second work machines for adjusting an operation of the first and second work machines based on the second set of project specifications.

15. The method of claim 14, wherein the command includes a signal to an electronic control module of the work machine that automatically adjusts the operation of each of the first and second work machines.

16. The method of claim 12, further including providing, from a remote location relative to the project environment, a command to the first work machine for adjusting an operation of the first work machine based on the second set of project specifications.

17. The method of claim 12, further including:
comparing the first set of project specifications with the second set of project specifications;
generating a project report indicative of a status of the project environment based on the comparison of the first set of project specification with the second set of project specifications; and
providing the project report to a subscriber of the project environment.

18. The method of claim 17, wherein the project report includes one or more recommendations for increasing productivity of the project environment based on the operational status of the first work machine.

19. The method of claim 17, wherein the project report includes one or more recommendations for reducing a cost associated with the project environment based on the operational status of the first work machine.

20. The method of claim 12, further including:
receiving, in the project management system, a fault condition from the first work machine;
adjusting a project schedule associated with the project environment in response to the fault condition; and
scheduling maintenance for the first work machine in response to the fault condition.

21. The method of claim 20, further including deploying a replacement work machine to the project environment in response to the fault condition.
